(19) United States
(12) Patent Application Publication
(10) Pub. No.: US 2016/0328719 A1
(43) Pub. Date: Nov. 10, 2016

(54) DATA NORMALIZATION FOR INTERNET OF THINGS (IoT) DEVICES

(71) Applicant: CA, Inc., New York, NY (US)

(72) Inventors: Dhesikan Ananchaperumal, Shrewsbury, MA (US); Bryan Rodney Diebold, Shrewsbury, MA (US)

(21) Appl. No.: 14/706,509

(22) Filed: May 7, 2015

(51) Int. Cl. G06Q 30/02; H04L 29/08

(52) U.S. Cl. CPC G06Q 30/0201; H04L 67/12

(57) ABSTRACT

An Internet of Things (IoT) device of a vendor is discovered based upon communications with the IoT device over a network. A vendor specific metric associated with the IoT device is identified based upon the communications with the IoT device over the network. The vendor specific metric is associated to a vendor agnostic metric. A standardized IoT device metric is determined based on the vendor specific metric and the vendor agnostic metric. Information expressed in terms of the vendor specific metric is received from the IoT device over the network. The information expressed in terms of the vendor specific metric is processed to obtain information expressed in terms of the standardized IoT device metric. Related methods, systems, and computer program products are provided.

### BACKGROUND

Various embodiments described herein relate to computer program products, methods and devices and computer systems, more specifically, to Internet of Things (IoT) computer program products, methods and computer systems.

The Internet of Things (IoT) is a network of physical objects or “things” that are uniquely identifiable and are embedded with communication network connectivity to enable them to achieve greater value and service by exchanging data with a user, operator, manufacturer, and/or other connected devices. IoT devices are proliferating across the world with the increase in use of technology, such as the Internet, virtualization, and cloud computing. IoT devices may include a variety of household appliances such as thermostats, power meters, water meters, refrigerators, washers/dryers, stoves, microwaves, dishwashers, toothbrushes, shavers, and/or televisions that include embedded network connectivity. IoT devices may also include a variety of other devices whose primary purpose is not network connectivity, but include embedded network connectivity such as medical devices including pacemakers, artificial limbs, casts and/or industrial devices such as motors, actuators, etc. Information about these IoT devices may be created by the “things” themselves such that the data gathered from the IoT devices may help reduce waste and cost by tracking the devices or their environment. Data from the IoT devices may also indicate when these “things” need replacing, repairing, recalling, or when they are past their prime functionality.

### SUMMARY

Some embodiments of the present inventive concepts are directed to a method including discovering an Internet of Things (IoT) device of a vendor based upon communications with the IoT device over a network, identifying a vendor specific metric associated with the IoT device based upon the communications with the IoT device over the network, associating the vendor specific metric to a vendor agnostic metric, and/or determining a standardized IoT device metric based on the vendor specific metric and the vendor agnostic metric. The method may include receiving information expressed in terms of the vendor specific metric from the IoT device over the network, and/or processing the information expressed in terms of the vendor specific metric to obtain information expressed in terms of the standardized IoT device metric.

According to various embodiments, the method may include, prior to the processing of the information, aggregating the information expressed in terms of the vendor specific metric from the IoT device to produce a reduced set of the information. In some embodiments, processing the information may include processing the reduced set of the information to obtain the information expressed in terms of the standardized IoT device metric.

In some embodiments, aggregating the information may include averaging the information expressed in terms of the vendor specific metric over time, and/or sampling the information expressed in terms of the vendor specific metric.

According to various embodiments, the vendor agnostic metric may include a first vendor agnostic metric. In some embodiments, determining the standardized IoT device metric based on the vendor specific metric and the vendor agnostic metric may include consolidating the first vendor agnostic metric with a second vendor agnostic metric to provide a consolidated vendor agnostic metric and/or determining the standardized IoT device metric based on the vendor specific metric and the consolidated vendor agnostic metric.

According to various embodiments, discovering the IoT device may include determining that the IoT device is visible to the network, determining a protocol used by the IoT device, and/or associating the IoT device to a vendor device certification based upon the protocol used by the IoT device. In some embodiments, identifying the vendor specific metric associated with the IoT device may include receiving the communications from the IoT device utilizing the protocol used by the IoT device, and/or identifying the vendor specific metric associated with the IoT device based on information received in the communications from the IoT device. In some embodiments, associating the IoT device to the vendor device certification may include determining the vendor associated with the IoT device, and/or selecting the vendor device certification based on at least one of the vendor, the protocol, or a model of the IoT device, in response to the vendor being on a list of supported vendors.

According to various embodiments, associating the vendor specific metric to the vendor agnostic metric may include associating the IoT device to a vendor variable in a vendor device certification based on the vendor specific metric. The vendor device certification may include the vendor variable and a vendor variable mapping. Associating the vendor specific metric to the vendor agnostic metric may include determining a vendor agnostic metric based on the vendor variable mapping. In some embodiments, associating the vendor specific metric to the vendor agnostic metric may include associating the IoT device to a vendor device certification, determining an IoT category associated with the IoT device based on the vendor device certification, and/or determining the vendor agnostic metric based on the IoT category. In some embodiments, determining the IoT category associated with the IoT device may include determining the IoT category based on information received in the communications from the IoT device or based on the vendor device certification.

According to various embodiments, determining the standardized IoT device metric based on the vendor specific metric and the vendor agnostic metric may include obtaining a conversion function to apply to the vendor specific metric based on the vendor agnostic metric to obtain the standardized IoT device metric. The conversion function may include a unit of measure. In some embodiments, processing the information associated with vendor specific metric to obtain information associated with the standardized IoT device metric may include generating information associated with the standardized IoT device metric by applying the conversion function to the information associated with vendor specific metric. In some embodiments, the method may include publishing the information expressed in terms of the standardized IoT device metric to an IoT cloud.

Various embodiments of the present inventive concepts are directed to a computer program product that comprises a non-transitory computer readable storage medium storing computer readable program code, which, when executed by a processor of an electronic device causes the processor to perform operations including discovering an Internet of Things (IoT) device of a vendor based upon communications with the IoT device over a network, identifying a vendor specific metric associated with the IoT device based upon the communications with the IoT device over the network, associating the vendor specific metric to a vendor agnostic metric, and/or determining a standardized IoT device metric based on the vendor specific metric and the vendor agnostic metric. The operations may include receiving information expressed in terms of the vendor specific metric from the IoT device over the network, and/or processing the information expressed in terms of the vendor specific metric to obtain information associated with the standardized IoT device metric. In some embodiments, the operations may include, prior to the processing the information, aggregating the information expressed in terms of the vendor specific metric from the IoT device to produce a reduced set of the information. The processing the information expressed in terms of the vendor specific metric to obtain information associated with the standardized IoT device metric may include processing the reduced set of the information to obtain the information expressed in terms of the standardized IoT device metric.

According to various embodiments, aggregating the information may include averaging the information associated with the vendor specific metric over time, or sampling the information associated with the vendor specific metric. In some embodiments, associating the vendor specific metric to the vendor agnostic metric may include associating the IoT device to a vendor variable in a vendor device certification based on the vendor specific metric. The vendor device certification may include the vendor variable and a vendor variable mapping. In some embodiments, the operations may include determining a vendor agnostic metric based on the vendor variable mapping.

According to various embodiments, determining the standardized IoT device metric based on the vendor specific metric and the vendor agnostic metric may include obtaining a conversion function to apply to the vendor specific metric based on the vendor agnostic metric to obtain the standardized IoT device metric. The conversion function may include a unit of measure.

Embodiments of the present inventive concepts may also be directed to computer systems that include a processor and a memory coupled to the processor. The memory may include computer readable program code embodied therein that, when executed by the processor, causes the processor to perform functions and operations as disclosed herein. The operations may include discovering an Internet of Things (IoT) device of a vendor based upon communications with the IoT device over a network, identifying a vendor specific metric associated with the IoT device based upon the communications with the IoT device over the network, associating the vendor specific metric to a vendor agnostic metric, determining a standardized IoT device metric based on the vendor specific metric and the vendor agnostic metric, receiving information associated with the vendor specific metric from the IoT device over the network, and/or processing the information associated with the vendor specific metric to obtain information associated with the standardized IoT device metric.

It is noted that aspects of the disclosure described with respect to one embodiment, may be incorporated in a different embodiment although not specifically described relative thereto. That is, all embodiments and/or features of any embodiment can be combined in any way and/or combination. These and other objects and/or aspects of the present invention are explained in detail in the specification set forth below.

### BRIEF DESCRIPTION OF THE DRAWINGS

Aspects of the present inventive concepts are illustrated by way of example and are not limited by the accompanying figures with like references indicating like elements.

FIG. 1 illustrates an Internet of Things (IoT) platform architecture, according to some embodiments of the present inventive concepts.

FIG. 2, FIG. 3, and FIG. 6 are block diagrams illustrating devices/modules that may be used according to some embodiments of the present inventive concepts.

FIG. 4 and FIG. 5 are flowcharts of operations that may be performed by the Edge Cloud Nodes (ECN) of any of FIGS. 1 to 3, according to some embodiments of the present inventive concepts.

FIG. 7 illustrates metrics associated with refrigerators as an example Internet of Things (IoT) devices, according to some embodiments of the present inventive concepts.

FIGS. 8 to 19 are flowcharts of operations of any of FIGS. 1 to 7, that may be performed when an IoT device is introduced in a network, according to some embodiments of the present inventive concepts.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout. Numerous specific details are set forth in order to provide a thorough understanding of embodiments of the present inventive concepts. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As noted above, Internet of Things (IoT) devices are proliferating across the world with the increase in use of technology such as the Internet, virtualization and cloud computing. IoT devices may include a multitude of household devices such as thermostats, power meters, water meters, refrigerators, washers/dryers, stoves, microwaves, dishwashers, and/or televisions that are uniquely identifiable and are embedded with communication network connectivity. As used herein, the term “IoT device” may refer to any device that may be connected to a network, such as the examples above. IoT devices may include a variety of different types of equipment and may be from a variety of different vendors and/or manufacturers. The different vendors and/or manufacturers may each provide device information using a variety of protocols, parameters, formats, and/or units. For example, an IoT device such as a refrigerator from the vendor Samsung may communicate using the BACnet protocol and provide variables to represent temperature in units of ° C., whereas a refrigerator from the vendor GE may communicate using the MQTT protocol and provide different variables to represent temperature in units of ° F.

Various embodiments described herein may arise from a recognition for a need to determine standardized IoT device metrics that are agnostic to the specific vendor provided information and/or variables. Vendor and/or device specific metrics communicated from an IoT device using different protocols may need to be normalized to standardized metrics that are independent of the specific device from the particular vendor. In some embodiments, data aggregation and/or consolidation may also be used to obtain standardized IoT device metrics. Various embodiments described herein provide methods, computer program products, and computer systems to normalize vendor specific metrics to standardized IoT device metrics.

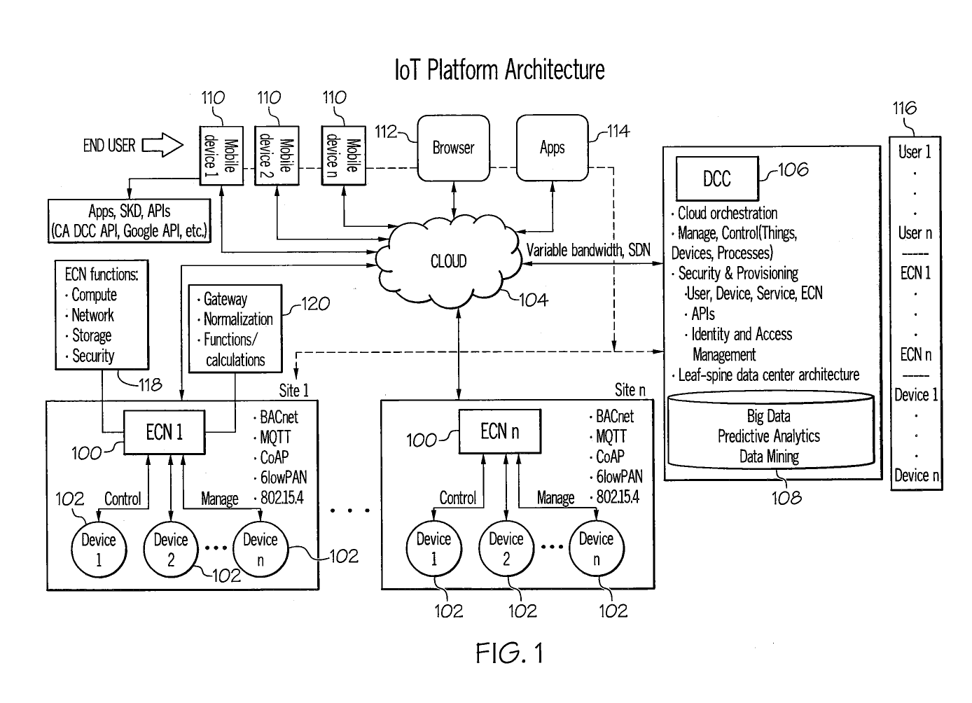

Referring now to FIG. 1, an Internet of Things (IoT) platform architecture is illustrated. One or more Edge Cloud Nodes (ECN) 100 may be included in the system. The ECN 100 may provide functions as illustrated in block 118 such as computations, network interfacing, storage of data, and/or security functions. The ECN 100 may control and/or manage one or more IoT devices 102. The ECN 100 may have an ability to communicate with IoT devices 102 using a variety of protocols such as BACnet, MQTT, CoAP, IPv6 over Low power Wireless Personal Area Networks (6lowPAN), and/or 802.15.4 for low-rate wireless personal area networks (LR-WPANs). As illustrated in block 120, the ECN 100 may function as a gateway and communicate using protocols such as BACnet, MQTT, CoAP, and/or 6lowPAN. ECN 100 may provide data normalization, data calculations, and/or other functions. Data normalization may include normalizing vendor specific metrics associated with an IoT device 102 to standardized IoT device metrics. The ECN 100 may communicate with an IoT cloud 104. The ECN 100 may store and/or receive IoT device information from the IoT cloud 104. The ECN 100 may receive configuration information, control parameters, and/or vendor information from the IoT cloud 104. A mobile device 110, browser 112, applications programs 114, and/or a desktop computer may be used by an end user or an operator to input configuration, data and/or control information into the IoT cloud 104 and/or the ECN 100. Mobile device 110 may interface to the IoT cloud 104 using Applications, a Software Development Kit (SDK), and or application program interfaces (APIs) such as Distributed Cloud Computing (DCC) API and/or Google API.

Still referring to FIG. 1, in some embodiments, the IoT platform architecture may include a Distributed Cloud Computing (DCC) node 106. DCC node 106 may interface with the IoT cloud 104 using variable bandwidth and/or Software-Defined Networking (SDN) using abstraction of lower-level functionality. DCC node 106 may perform cloud orchestration through the automated arrangement, coordination, and/or management of complex computer systems, middleware, and/or services. The DCC node 106 may manage and/or control “things”, devices, and/or processes related to an IoT network. In some embodiments, DCC node 106 may be responsible for security and provisioning of users 110, devices 102, services, and/or ECNs 100 associated with an IoT network. DCC node 106 may provide identity and access management of IoT devices and may be accessible through application program interfaces (APIs) provided to users 110 and/or network administrators. DCC node 106 may be integrated into a leaf-spine data center architecture where lower throughput leaf switches mesh into the spine, which may be a series of several high throughput switches with high port density. In a leaf-spine architecture, spine nodes may be part of the core of the architecture, whereas leaf nodes may be at the access layer and deliver network connection points for servers. Leaf nodes may provide uplinks to spine nodes. In some embodiments, DCC node 106 may be part of the spine of the network, whereas ECN 100 may be part of the leaf nodes of the network. In some embodiments, DCC node 106 may include a database or other data storage component 108 that may be configured to perform big data predictive analytics and/or data mining. The data storage component 108 may perform analytical processing to process large amounts of data, i.e. “big data”, to search for consistent patterns and/or systematic relationships between variables. In some embodiments, ECN 100 may perform big data predictive analytics and/or data mining. DCC node 106 may include and/or be associated with data structures 116 that organize data related to users, ECNs, and/or “things”. In some embodiments, data structures 116 may be part of the DCC node 106 and/or may be external to the DCC node 106.

According to some embodiments, the ECN 100 may include hardware and/or software that is connected to a network. In some embodiments, the ECN 100 may be a part of a network connection device such as a router, a server, and/or an IoT device 102. An ECN 100 may be an independent device internal or external to a network including a cloud, Distributed Cloud Computing (DCC) node 106, a router, a gateway, and/or an IoT device 102. The ECN may serve as a gateway to a local area network (LAN) including various IoT devices 102, mobile devices 110, and/or desktop computers. In some embodiments, the ECN may serve as a gateway to a wide area network (WAN) including an internet cloud 104, a DCC node 106, a server, and/or a router.

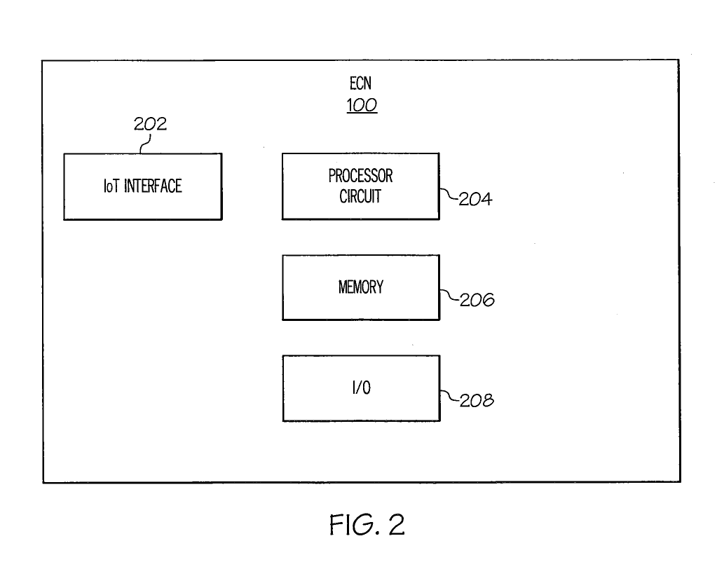

Referring now to FIG. 2, a block diagram of the ECN 100 of FIG. 1 is illustrated. ECN 100 may include an IoT interface 202, a processor circuit 204, a memory 206, and/or an I/O 208. In some embodiments, computer program instructions may be stored in the memory 206 and may be provided to a processor circuit 204, such that the instructions execute via the processor circuit 204 of the ECN 100. In some embodiments, the processor circuit 204 may be configured to perform operations of various modules, as illustrated in FIG. 3. Referring now to FIG. 3, a block diagram of the ECN 100 of FIGS. 1 and 2, including various modules is illustrated. Modules of FIG. 3, such as the discovery module 302, the device/vendor certification module 308, vendor agnostic metric definition module 310, the normalization module 306, and/or the data collection module 304 may be stored in memory 206 and may be executed by processor circuit 204 of FIG. 2. One of more IoT devices 102 may communicate using protocols such as MQTT, XMPP, CoAP, Modbus, Bacnet, and/or SNMP to the ECN 100. The ECN 100 may include a discovery module 302 configured to discover an IoT device 102 of a vendor based upon communications with the IoT device 102 over a network. According to some embodiments, determining that the IoT device 102 is visible to the network by discovery module 302 may include determining a protocol used by the IoT device 102, and/or associating the IoT device 102, based upon the protocol used by the IoT device 102, to a vendor device certification in a device/vendor certification module 308. The device/vendor certification module 308 may include a list of supported vendors 316. The discovery module 302 may determine the vendor of the IoT device 102 and then check if the vendor is in the list of supported vendors 316. In some embodiments, the device/vendor certification module 308 may include one or more vendor certifications 318a, 318b, 318c, and/or 318d. In response to the vendor being on a list of supported vendors, the discovery module 302 may select a vendor device certification 318a, 318b, 318c, or 318d based on the vendor, the protocol, and/or a model of the IoT device.

Still referring to FIG. 3, in some embodiments, vendor certifications “certs” 318a, 318b, 318c, or 318d may include a model of the device, variables such as vendor specific metrics and/or a mapping to a vendor agnostic metric. The device/vendor certification module 308 may identify a vendor specific metric associated with the IoT device 102 based upon communications with the IoT device 102 over the network. Identifying the vendor specific metric associated with the IoT device 102 may be based on information received in the communications from the IoT device 102. The IoT device 102 may be associated to a vendor variable in a vendor certification 318a, 318b, 318c, or 318d based on the vendor specific metric. A vendor certification 318a, 318b, 318c, or 318d may include a vendor variable and a corresponding vendor variable mapping to a vendor agnostic metric 322 in a vendor agnostic metric definition module 310. A vendor agnostic metric 322 may be determined based on the vendor variable mapping in the vendor certification 318a, 318b, 318c, or 318d.

In some embodiments, associating the vendor specific metric to the vendor agnostic metric may include associating the IoT device 102 to a vendor device certification 318, determining an IoT category 320 associated with the IoT device 102 based on the vendor device certification 318, and/or determining the vendor agnostic metric 322 based on the IoT category 320. The IoT category 320 may be determined based on information received in the communications from the IoT device 102 or based on the vendor device certification 318.

Still referring to FIG. 3, according to some embodiments, a standardized IoT device metric 312 may be determined by a normalization module 306 based on the vendor specific metric in the vendor device certification 318 and the vendor agnostic metric 322 by a normalization module 306. Determining the standardized IoT device metric 312 may include obtaining a conversion function to apply to the vendor specific metric in the vendor certification 318 based on the vendor agnostic metric 322 in order to obtain the standardized IoT device metric 312. The conversion function may include a unit of measure and/or a function to apply to data to obtain the correct unit of measure.

According to some embodiments, the data collection module 304 may receive information expressed in terms of the vendor specific metric from the IoT device 102 over the network. Data may be received by the IoT device 102 using protocols such as MQTT, XMPP, CoAP, Modbus, BACnet, SNMP. In some embodiments, the specific protocol in use may determine actions on the data. For example, IoT devices using Modbus may have vendor certifications that define register offsets and their mapping to agnostic metrics. MQTT devices may have vendor certifications defining variable extraction from MQTT topics and mapping of these MQTT topics to agnostic metrics. In some embodiments, device discovery parameters may depend upon the protocol and may include the IoT device IP address and/or port number. The data collection module 304 may provide the information expressed in terms of the vendor specific metric to the normalization module 306. The normalization module 306 may process the information expressed in terms of the vendor specific metric to obtain information expressed in terms of the standardized IoT device metric 312. The normalization module 306 may generate information associated with the standardized IoT device metric 312 by applying the conversion function to the information associated with vendor specific metric. The normalization module 306 may publish the information expressed in terms of the standardized IoT device metric to an IoT cloud 314. The IoT cloud 314 of FIG. 3 may correspond to the IoT cloud 104 of FIG. 1 and may include storage of variables and/or data, functions to manipulate the variables and/or data, analytical processing, and/or other cloud-based functions.

Still referring to FIG. 3, according to some embodiments, the normalization module 306 may perform additional functions. The normalization module 306 may aggregate information expressed in terms of the vendor specific metric from the IoT device to produce a reduced set of the information, prior to processing the information. The reduced set of the information may be then processed to obtain the information expressed in terms of the standardized IoT device metric. In some embodiments, aggregating the information may include averaging the information expressed in terms of the vendor specific metric over time. The time period over which the information is averaged may depend upon historical data and/or trends. In cases where the IoT device may publish data values at intervals higher than an interval specified by the vendor certification and/or vendor agnostic metric definition, the normalization module 306 may average data values. In some embodiments, the information expressed in terms of the vendor specific metric may be sampled to arrive at a reduced set of information. Sampling may occur periodically or asynchronously. For example, for an IoT device such as a thermostat, temperature may change rapidly during certain parts of the day, such as in the morning from 7 am to 10 am. In this case, sampling of information from the thermostat may occur more frequently during this time window and less frequently during other time intervals.

According to some embodiments, different vendor agnostic metrics may be consolidated with one another to arrive at a consolidated vendor agnostic metric. For example, the current and the voltage of an IoT device such as a clothes dryer may be consolidated using a function such as Power=Current*Voltage. The resulting consolidated vendor agnostic metric, Power, may be used along with one or more vendor specific metrics to determine a standardized IoT device metric. In some embodiments, consolidation may occur periodically or may occur asynchronously at different time windows. The time windows for consolidation may be based on historical data, trends, operator input, user preferences, and/or user behavior. As described herein, aggregation, averaging, sampling, and/or consolidation may occur for specific IoT device categories, specific vendors, and/or particular vendor device certifications. As described herein, aggregation, averaging, sampling, and/or consolidation of information may occur in any or all combinations.

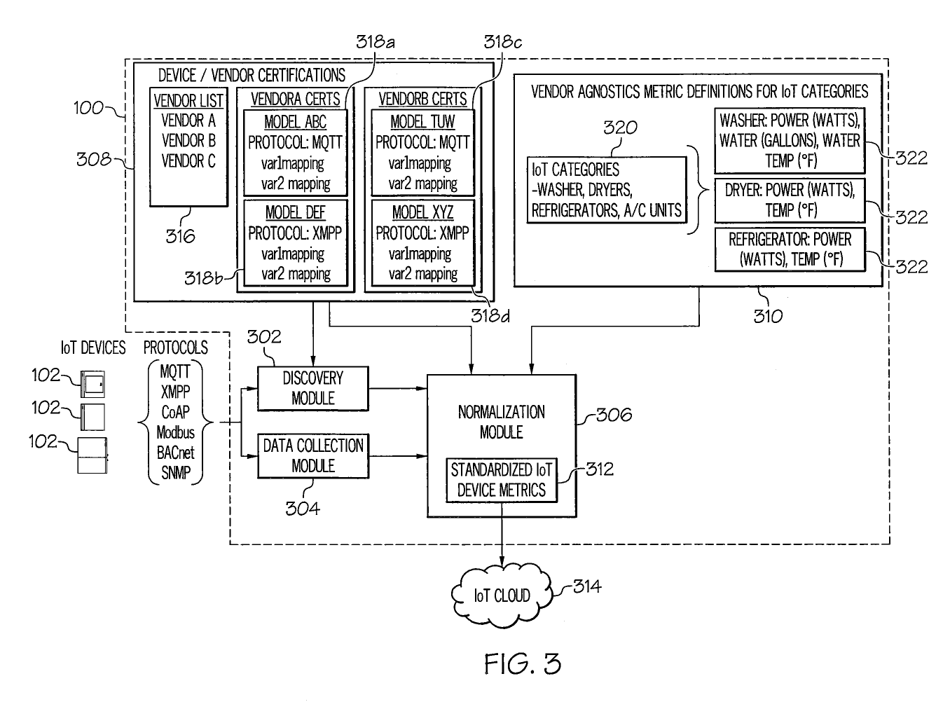

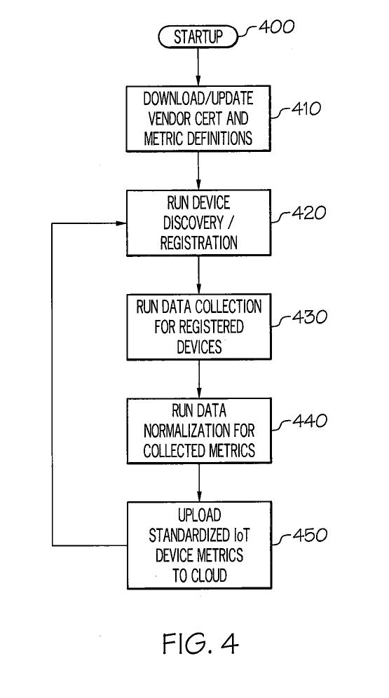

Referring now to FIG. 4, a flowchart of operations that may be performed by an Edge Cloud Node (ECN) is illustrated. These operations may be executed by any of the modules of FIG. 3 and may be stored in memory 206 of FIG. 2 to be executed by processor circuit 204 of FIG. 2. At block 400, startup of the ECN 100 of any of FIGS. 1 to 3 may occur. After startup, at block 410, vendor certifications and metric definitions may be downloaded or updated from a remote server and/or from the DCC 106 of FIG. 1. In some embodiments, vendor certifications may be obtained from various vendors and/or manufacturers of IoT devices. At block 420, a device discovery and/or registration process may be run to determine specific devices, types, and/or protocols that correspond to a vendor certification library. In some embodiments, a device registration request may be received from an IoT device, an end user, a DCC node and/or other access devices. New devices that match properties in a vendor certification may be added to the data collection module 304 of FIG. 3. For devices that are unknown and/or do not match an existing vendor certification, the ECN may provide a query or prompts for additional information that may be used to populate a vendor certification. The additional information may be supplied by a user, a vendor, a database, and/or a server in the system. A new vendor certification may be created for an IoT device during discovery and/or registration. At block 430, data collection for registered devices may occur. Data collection may include extraction of data variables from the actual IoT devices. IoT device data variables may be extracted from protocol specific data. Data collection may occur periodically or historical data stored at the IoT device may be requested. In some embodiments, time average or other transformation of the data from the IoT device may occur. Data used for historical processing, time averaging, and/or other transformations may be stored at the ECN 100, cloud 104, and/or at the DCC 106 of FIG. 1. In some embodiments, data collection may occur by IoT device polling at polling time intervals that are associated with the vendor certification. The polling interval may be different from the reporting interval. For example, the IoT device may be polled every 10 minutes but data may be reported hourly. In some embodiments, the IoT device may push and/or publish data to the ECN.

Still referring to FIG. 4, the collected metrics and/or data from the IoT device may be normalized at block 440. In some embodiments, the raw data from the IoT device may be manipulated to arrive at more meaningful data. For example, the raw data may be scaled, merged with other data, converted to different units, and/or mathematically manipulated. The data normalization may result in information related to a standardized IoT device metric. In some embodiments, resulting normalized data may be independent of the vendor of the IoT device since vendor agnostic metric definitions may be downloaded or otherwise available to the normalization module. The normalization module may process device data and/or transform values of the data to vendor agnostic metric categories. Vendor agnostic categories may be defined for different business segments or for specific customer requirements. Categories may be updated and maintained in a library and/or database and may be retrieved by the data normalization module as needed. Once the data has been normalized, the vendor agnostic metrics may be published to the IoT cloud, which may include an IoT cloud server. Published metrics may be used for analytics and/or reporting in the IoT cloud. At block 450, the information related to the standardized IoT device metric may be uploaded to an IoT cloud. In some embodiments, the information related to the standardized IoT device metric may be used to update the device registration from the discovery operation.

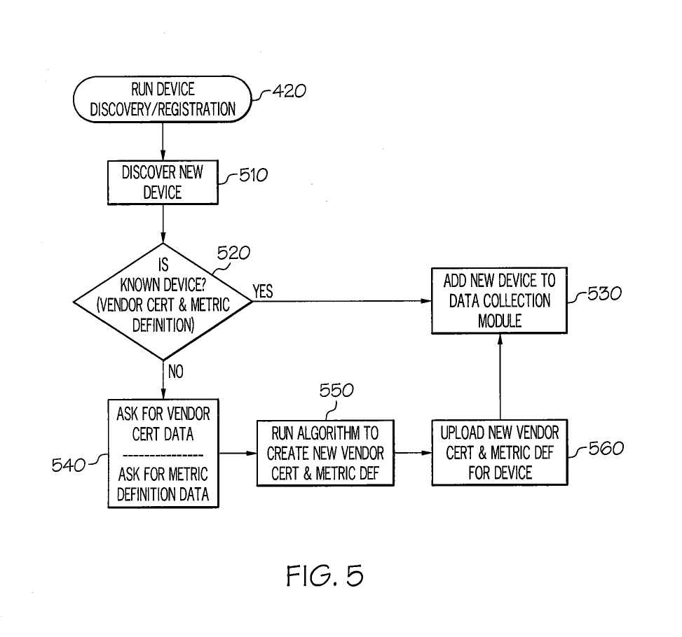

Referring now to FIG. 5, a flowchart of operations that may be performed at block 420 of FIG. 4 for IoT device discovery and registration is illustrated. At block 510, a new IoT device may be discovered on the network. At block 520, the ECN may determine if the IoT device is known by checking for a matching vendor certification including metric definitions. Vendor certifications may be stored in a library and/or database which may be updated regularly with new device models, device protocol mappings, and/or model identification information such as vendor name, model identification, etc. If the IoT device is known, operations proceed to block 530 to add the new IoT device to the data collection module. If the IoT is unknown to the ECN, operations proceed to block 540 to request a user, operator, vendor, and/or manufacturer for vendor certification data and/or metric definition data. Operations may proceed to block 550, to run an algorithm to create a new vendor certification and/or metric definitions based on information received in response to the request of block 540. At block 560, the new vendor certification may be uploaded to the database of vendor certifications for use by the IoT device. Operations may then proceed to block 530 to add the IoT device to the data collection module based on the new vendor certification. In some embodiments, if sufficient details regarding the IoT device are not available during discovery, the device may be discarded and/or reported to IoT cloud services for analysis regarding reasons for discarding.

Referring now to FIG. 6, a conversion function utilized by the standardized IoT device metrics module 312 of FIG. 3 is illustrated. Vendor specific metric information 610 may be input to the conversion function 620 that is associated with the standardized IoT device metrics. The conversion function 620 may be applied to the vendor specific metric information 610 to obtain standardized IoT device metric information 630. This standardized IoT device metric information 630 may be published to the IoT cloud 314 of FIG. 3.

### Example

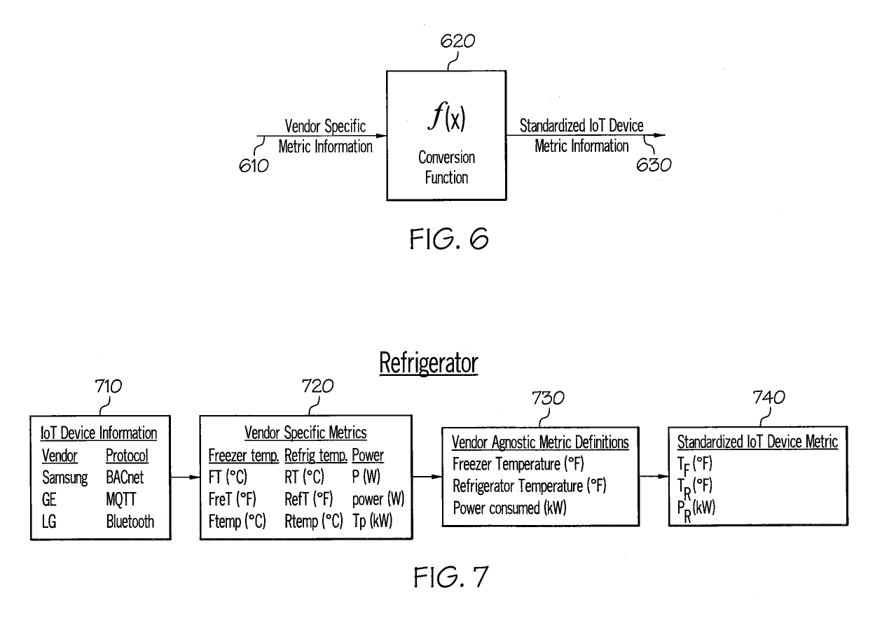

The following Example shall be regarded as merely illustrative and shall not be construed as limiting the invention. This is an end-to-end example to illustrate various metrics related an IoT devices such as a refrigerators. Referring now to FIG. 7, a working example including metrics associated with refrigerators as example Internet of Things (IoT) devices, is illustrated. Block 710 illustrates IoT device information for three different refrigerators from the vendors Samsung, GE, and LG. The refrigerator from Samsung may communicate across a network using BACnet protocol. The refrigerator from GE may communicate across a network using MQTT protocol. The refrigerator from LG may communicate across a network using Bluetooth protocol. For example, the Samsung refrigerator may be introduced to a network including an ECN, as illustrated in FIG. 3. The Samsung refrigerator may communicate with the discovery module 302 of the ECN of FIG. 3 using the BACnet protocol. The discovery module 302 may determine the vendor of the Samsung refrigerator. The discovery module 302 of FIG. 3 may coordinate with the device/vendor certification module 308 of FIG. 3 to check to see if Samsung is in the list of supported vendors 316. The device/vendor certification module 308 of FIG. 3 may select a vendor device certification 318 of FIG. 3 based on the vendor, the protocol, and/or a model of the Samsung refrigerator. The vendor device certification 318 of FIG. 3 may include variables such as one or more vendor specific metrics 720 that are associated with the Samsung refrigerator. The vendor specific metrics 720 associated with the Samsung refrigerator may include a freezer temperature FT in ° C., a refrigerator temperature RT in ° C., and/or power P used by the refrigerator in Watts. The vendor specific metrics 720 in the vendor device certification 318 of FIG. 3 may be mapped to corresponding vendor agnostic metrics 730 as was described, for example, with respect to block 440 of FIG. 4. In this foregoing example, the corresponding vendor agnostic metrics may include the Freezer Temperature in ° F., Refrigerator Temperature in OF, and/or Power Consumed in kW. Standardized IoT device metrics 740 may be determined by the normalization module 306 of FIG. 3 based on the vendor specific metrics 720 and the vendor agnostic metrics 730. The standardized IoT device metrics 740 may include a conversion function to be applied to vendor specific metric data. In the foregoing example, the standardized IoT device metric T_{F} in ° F. may be obtained by applying a function to convert ° C. to ° F. such as T_{F}=1.8*(FT)+320. The power consumed P_{R} may be include unit conversion for the Samsung refrigerator to convert W to kW using a function such as P_{R}=P*0.001. These functions may be utilized by the normalization module 306 of FIG. 3 to obtain standardized IoT device data that may be published to the IoT cloud.

### Additional Embodiments

Additional embodiments including operations that may be performed by an ECN will now be discussed. FIGS. 8 to 19 are flowcharts of operations that may be performed when an IoT device is introduced in a network. Referring now to FIG. 8, an Internet of Things (IoT) device may be introduced to a network at block 800, which may be embodied, for example, as an IoT device 102 of FIG. 1 or FIG. 3. The IoT device of a vendor may be discovered based upon communications with the IoT device over the network, at block 810. A vendor specific metric associated with the IoT device may be identified based on communications with the IoT device over the network, at block 820. The vendor specific metric may be associated to a vendor agnostic metric, at block 830. A standardized IoT device metric may be determined based on the vendor specific metric and the vendor agnostic metric, at block 840. In some embodiments, information expressed in terms of the vendor specific metric may be received from the IoT device over the network, at block 850. The information expressed in terms of the vendor specific metric may be processed to obtain information expressed in terms of the standardized IoT device metric, at block 860.

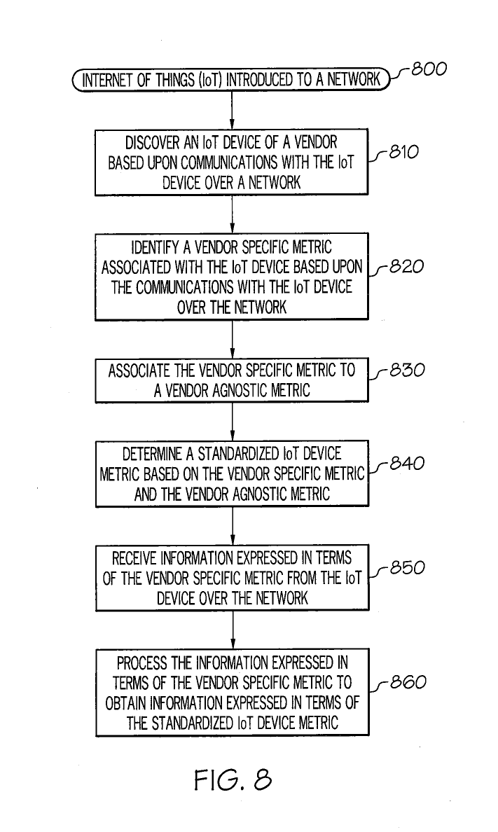

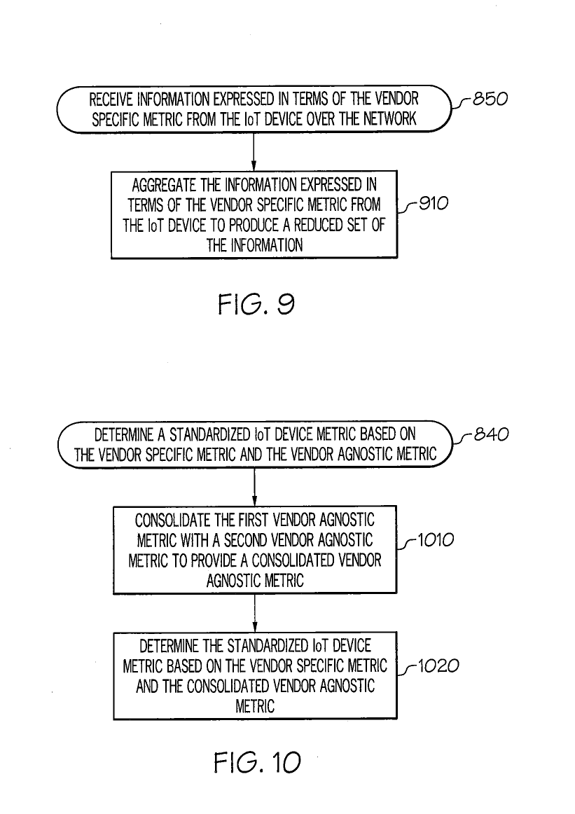

FIG. 9 is a flowchart of operations after receiving information expressed in terms of the vendor specific metric from the IoT device over the network, according to some embodiments of the present inventive concepts, which may correspond to block 850 of FIG. 8. Referring now to FIG. 9, at block 910, prior to the processing the information, the information expressed in terms of the vendor specific metric from the IoT device may be aggregated to produce a reduced set of the information. The reduced set of the information may be processed to obtain information expressed in terms of the standardized IoT device metric.

FIG. 10 is a flowchart of operations for determining the standardized IoT device metric based on the vendor specific metric and the vendor agnostic metric, according to some embodiments of the present inventive concepts, which may correspond to block 840 of FIG. 8. Referring now to FIG. 10, at block 1010, a first vendor agnostic metric may be consolidated with a second vendor agnostic metric to provide a consolidated vendor agnostic metric. The standardized IoT device metric may be determined based on the vendor specific metric and the consolidated vendor agnostic metric, at block 1020.

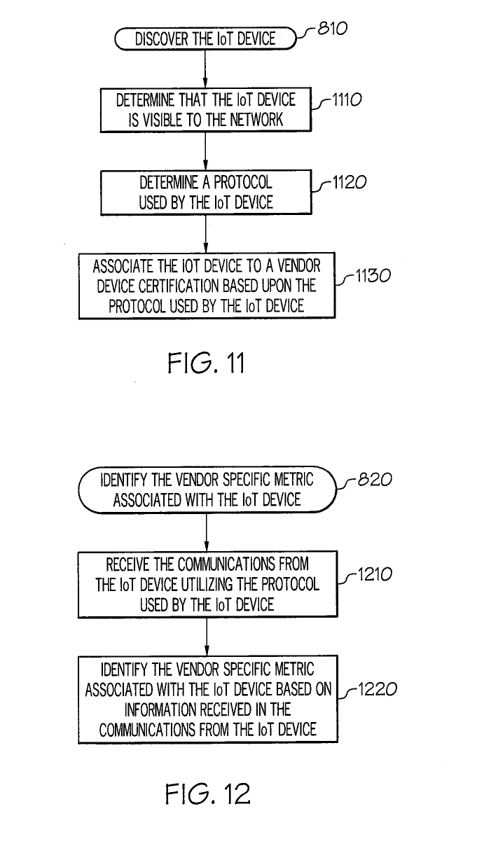

FIG. 11 is a flowchart of operations for discovering an IoT device, according to some embodiments of the present inventive concepts, which may correspond to block 810 of FIG. 8. Referring now to FIG. 11, at block 1110, discovering the IoT device may include determining that the IoT device is visible to the network, determining a protocol used by the IoT device, at block 1120, and/or associating the IoT device to a vendor device certification based upon the protocol used by the IoT device, at block 1130.

FIG. 12 is a flowchart of operations for identifying the vendor specific metric associated with the IoT device, according to some embodiments of the present inventive concepts, which may correspond to block 820 of FIG. 8. Referring now to FIG. 12, at block 1210, communications from the IoT device may be received utilizing the protocol used by the IoT device. The vendor specific metric associated with the IoT device may be identified based on information received in the communications from the IoT device, at block 1220.

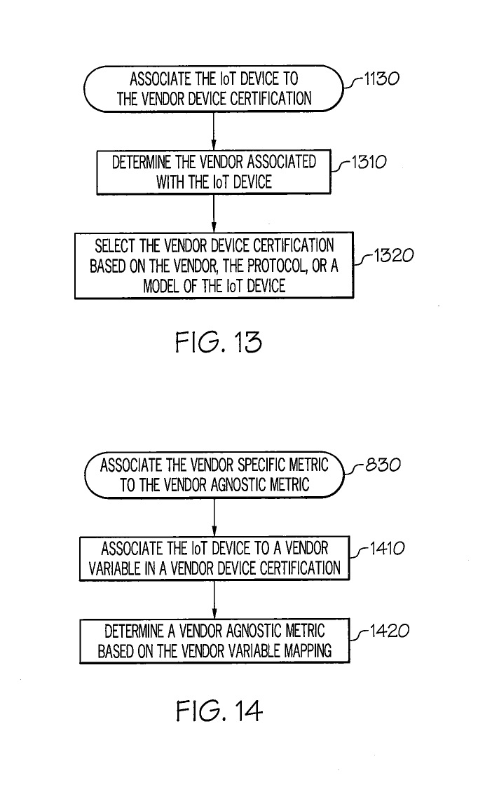

FIG. 13 is a flowchart of operations for associating the IoT device to the vendor device certification, according to some embodiments of the present inventive concepts, which may correspond to block 1130 of FIG. 11. Referring now to FIG. 13, at block 1310, the vendor associated with the IoT device may be determined. A vendor device certification may be selected based on the vendor, the protocol, or a model of the IoT device, at block 1320. The selection of the vendor device certification may be made in response to the vendor being on a list of supported vendors.

FIG. 14 is a flowchart of operations for associating the vendor specific metric to the vendor agnostic metric, according to some embodiments of the present inventive concepts, which may correspond to block 830 of FIG. 8. Referring now to FIG. 14, at block 1410, the IoT device may be associated to a vendor variable in a vendor device certification based on the vendor specific metric. In some embodiments, the vendor device certification may include a vendor variable and a vendor variable mapping. A vendor agnostic metric may be determined based on the vendor variable mapping in the vendor device certification, at block 1420.

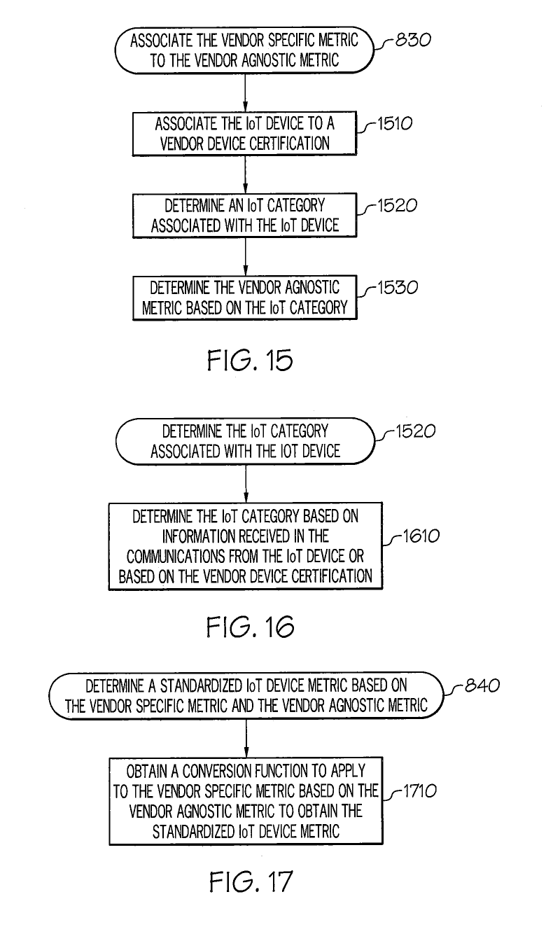

FIG. 15 is a flowchart of operations for associating the vendor specific metric to the vendor agnostic metric, according to some embodiments of the present inventive concepts, which may correspond to block 830 of FIG. 8. Referring now to FIG. 15, at block 1510, the IoT device may be associated to a vendor device certification. An IoT category associated with the IoT device may be determined based on the vendor device certification, at block 1520. The vendor agnostic metric may be determined based on the IoT category, at block 1530.

FIG. 16 is a flowchart of operations for determining the IoT category associated with the IoT device, according to some embodiments of the present inventive concepts, which may correspond to block 1520 of FIG. 15. Referring now to FIG. 16, at block 1610 the IoT category may be determined based on information received in the communications from the IoT device or based on the vendor device certification.

FIG. 17 is a flowchart of operations for determining a standardized IoT device metric based on the vendor specific metric and the vendor agnostic metric, according to some embodiments of the present inventive concepts, which may correspond to block 840 of FIG. 8. Referring now to FIG. 17, at block 1710, a conversion function to apply to the vendor specific metric may be obtained based on the vendor agnostic metric to obtain the standardized IoT device metric. In some embodiments, the conversion function may include a unit of measure.

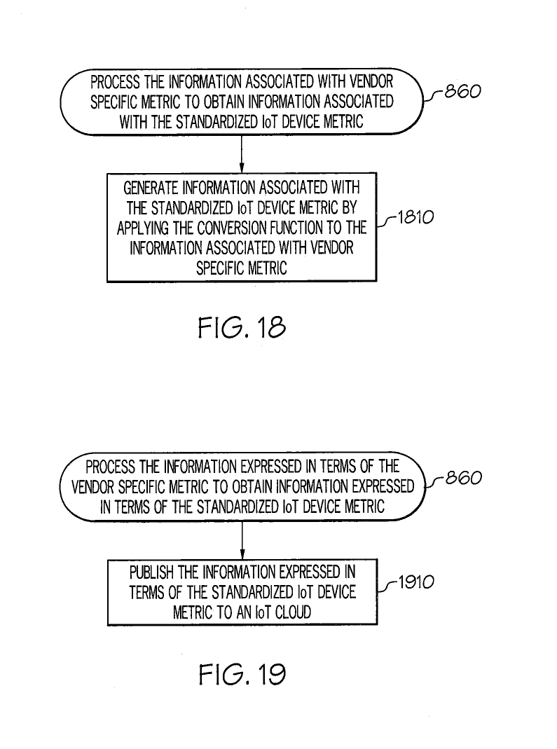

FIG. 18 is a flowchart of operations for processing the information expressed in terms of the vendor specific metric to obtain information expressed in terms of the standardized IoT device metric, according to some embodiments of the present inventive concepts, which may correspond to block 860 of FIG. 8. Referring now to FIG. 18, at block 1810, information associated with the standardized IoT device metric may be generated by applying the conversion function to the information associated with vendor specific metric.

FIG. 19 is a flowchart of operations for processing the information expressed in terms of the vendor specific metric to obtain information expressed in terms of the standardized IoT device metric, according to some embodiments of the present inventive concepts, which may correspond to block 860 of FIG. 8. Referring now to FIG. 19, at block 1910, the information expressed in terms of the standardized IoT device metric may be published to an IoT cloud.

### Further Definitions and Embodiments

In the above-description of various embodiments of the present inventive concepts, aspects of the present inventive concepts may be illustrated and described herein in any of a number of patentable classes or contexts including any new and useful process, machine, manufacture, or composition of matter, or any new and useful improvement thereof. Accordingly, aspects of the present inventive concepts may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present inventive concepts may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present inventive concepts may be written in any combination of one or more programming languages, including an object oriented programming language such as Java, Scala, Smalltalk, Eiffel, JADE, Emerald, C++, C#, VB.NET, Python, etc., conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present inventive concepts are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the terminology used herein is for the purpose of describing particular embodiments only and is not intended to be limiting to other embodiments. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the Figures illustrate the architecture, functionality, and operation of possible implementations of systems, methods, and computer program products according to various aspects of the present inventive concepts. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the Figures.

The corresponding structures, materials, acts, and equivalents of any means or step plus function elements in the claims below are intended to include any disclosed structure, material, or act for performing the function in combination with other claimed elements as specifically claimed. The description of the present inventive concepts has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

In the drawings and specification, there have been disclosed typical embodiments and, although specific terms are employed, they are used in a generic and descriptive sense only and not for purposes of limitation, the scope of the disclosure being set forth in the following claims.

What is claimed is:

1. A method comprising:
discovering an Internet of Things (IoT) device of a vendor based upon communications with the IoT device over a network;
identifying a vendor specific metric associated with the IoT device based upon the communications with the IoT device over the network;
associating the vendor specific metric to a vendor agnostic metric;
determining a standardized IoT device metric based on the vendor specific metric and the vendor agnostic metric;
receiving information expressed in terms of the vendor specific metric from the IoT device over the network; and
processing the information expressed in terms of the vendor specific metric to obtain information expressed in terms of the standardized IoT device metric.

2. The method according to claim 1, further comprising:
prior to the processing the information, aggregating the information expressed in terms of the vendor specific metric from the IoT device to produce a reduced set of the information,
wherein the processing comprises processing the reduced set of the information to obtain the information expressed in terms of the standardized IoT device metric.

3. The method according to claim 2,
wherein the aggregating the information comprises at least one of: averaging the information expressed in terms of the vendor specific metric over time, or sampling the information expressed in terms of the vendor specific metric.

4. The method according to claim 1, wherein the vendor agnostic metric comprises a first vendor agnostic metric, and wherein the determining the standardized IoT device metric based on the vendor specific metric and the vendor agnostic metric comprises:
consolidating the first vendor agnostic metric with a second vendor agnostic metric to provide a consolidated vendor agnostic metric; and
determining the standardized IoT device metric based on the vendor specific metric and the consolidated vendor agnostic metric.

5. The method according to claim 1,
wherein the vendor agnostic metric comprises a first vendor agnostic metric, and
wherein the determining the standardized IoT device metric based on the vendor specific metric and the vendor agnostic metric comprises:
consolidating the first vendor agnostic metric with a second vendor agnostic metric to provide a consolidated vendor agnostic metric; and
determining the standardized IoT device metric based on the vendor specific metric and the consolidated vendor agnostic metric,
the method further comprising:
prior to the processing the information, aggregating the information expressed in terms of the vendor specific metric from the IoT device to produce a reduced set of the information,
wherein the processing comprises processing the reduced set of the information to obtain the information expressed in terms of the standardized IoT device metric.

6. The method according to claim 1, wherein discovering the IoT device comprises:
determining that the IoT device is visible to the network;
determining a protocol used by the IoT device; and
associating the IoT device to a vendor device certification based upon the protocol used by the IoT device.

7. The method according to claim 6, wherein the identifying the vendor specific metric associated with the IoT device comprises:
receiving the communications from the IoT device utilizing the protocol used by the IoT device; and
identifying the vendor specific metric associated with the IoT device based on information received in the communications from the IoT device.

8. The method according to claim 6, wherein the associating the IoT device to the vendor device certification comprises:
determining the vendor associated with the IoT device; and
selecting the vendor device certification based on at least one of the vendor, the protocol, or a model of the IoT device, in response to the vendor being on a list of supported vendors.

9. The method according to claim 1, wherein the associating the vendor specific metric to the vendor agnostic metric comprises:
associating the IoT device to a vendor variable in a vendor device certification based on the vendor specific metric, wherein the vendor device certification comprises the vendor variable and a vendor variable mapping; and
determining a vendor agnostic metric based on the vendor variable mapping.

10. The method according to claim 1, wherein the associating the vendor specific metric to the vendor agnostic metric comprises:
associating the IoT device to a vendor device certification;
determining an IoT category associated with the IoT device based on the vendor device certification; and
determining the vendor agnostic metric based on the IoT category.

11. The method according to claim 10, wherein the determining the IoT category associated with the IoT device comprises:
determining the IoT category based on information received in the communications from the IoT device or based on the vendor device certification.

12. The method according to claim 1, wherein the determining the standardized IoT device metric based on the vendor specific metric and the vendor agnostic metric comprises:
obtaining a conversion function to apply to the vendor specific metric based on the vendor agnostic metric to obtain the standardized IoT device metric,
wherein the conversion function comprises a unit of measure.

13. The method according to claim 12, wherein the processing the information associated with vendor specific metric to obtain information associated with the standardized IoT device metric comprises:
generating information associated with the standardized IoT device metric by applying the conversion function to the information associated with vendor specific metric.

14. The method according to claim 1, further comprising:
publishing the information expressed in terms of the standardized IoT device metric to an IoT cloud.

15. A computer program product comprising:
a computer readable storage medium having computer readable program code embodied in the medium, that when executed by a processor of a computer system, causes the computer system to perform operations comprising:
discovering an Internet of Things (IoT) device of a vendor based upon communications with the IoT device over a network;
identifying a vendor specific metric associated with the IoT device based upon the communications with the IoT device over the network;
associating the vendor specific metric to a vendor agnostic metric;
determining a standardized IoT device metric based on the vendor specific metric and the vendor agnostic metric;
receiving information expressed in terms of the vendor specific metric from the IoT device over the network; and
processing the information expressed in terms of the vendor specific metric to obtain information associated with the standardized IoT device metric.

16. The computer program product of claim 15, wherein the operations further comprise:
prior to the processing the information, aggregating the information expressed in terms of the vendor specific metric from the IoT device to produce a reduced set of the information,
wherein the processing comprises processing the reduced set of the information to obtain the information expressed in terms of the standardized IoT device metric.

17. The computer program product of claim 16,
wherein the aggregating the information comprises at least one of: averaging the information associated with the vendor specific metric over time, or sampling the information associated with the vendor specific metric.

18. The computer program product of claim 15, wherein the associating the vendor specific metric to the vendor agnostic metric comprises;
associating the IoT device to a vendor variable in a vendor device certification based on the vendor specific metric, wherein the vendor device certification comprises the vendor variable and a vendor variable mapping; and
determining a vendor agnostic metric based on the vendor variable mapping.

19. The computer program product of claim 15, wherein the determining the standardized IoT device metric based on the vendor specific metric and the vendor agnostic metric comprises:
obtaining a conversion function to apply to the vendor specific metric based on the vendor agnostic metric to obtain the standardized IoT device metric,
wherein the conversion function comprises a unit of measure.

20. A computer system comprising:
a processor; and
a memory coupled to the processor, the memory comprising computer readable program code embodied therein that, when executed by the processor, causes the processor to perform operations comprising:
discovering an Internet of Things (IoT) device of a vendor based upon communications with the IoT device over a network;
identifying a vendor specific metric associated with the IoT device based upon the communications with the IoT device over the network;
associating the vendor specific metric to a vendor agnostic metric;
determining a standardized IoT device metric based on the vendor specific metric and the vendor agnostic metric;
receiving information associated with the vendor specific metric from the IoT device over the network; and
processing the information associated with the vendor specific metric to obtain information associated with the standardized IoT device metric.
